(19) United States
(12) Patent Application Publication
(10) Pub. No.: US 2014/0046843 A1
(43) Pub. Date: Feb. 13, 2014

(54) Leverage Transaction Card Acceptor Name for Cardholder Communication

(71) Applicant: Maurice David Liscia, Long Island City, NY (US)

(72) Inventor: Maurice David Liscia, Long Island City, NY (US)

(73) Assignee: MASTERCARD INTERNATIONAL, INC., Purchase, NY (US)

(21) Appl. No.: 13/568,366

(22) Filed: Aug. 7, 2012

(51) Int. Cl. G06Q 20/40

(52) U.S. Cl. 705/44

(57) ABSTRACT

A method for providing enhanced merchant information to the user of a cashless payment device generally includes the step of receiving a transaction request from an acquirer on behalf of a merchant in a cashless transaction clearing record, wherein the transaction request includes data identifying the merchant and the payment device. The data identifying the merchant is then compared to a database including a list of participating merchants to determine if a match exists in the database. In response to determining a match exists, it is then determined whether the data identifying the merchant in the transaction request should be enhanced with additional merchant information or information about a program the merchant participates in. If so, data enhancement is performed and the transaction request having the additional merchant or program information is forwarded to an issuer of the payment device.

### BACKGROUND OF THE INVENTION

The present invention relates to electronic transaction processing. More particularly, the present disclosure is directed to a method and system for communicating with a payment cardholder based on electronic transactions involving the card acceptor.

The use of payment cards for a broad spectrum of cashless transactions has become ubiquitous in the current economy, accounting for hundreds of billions of dollars in transactions during 2010 alone. The process and parties involved can be visualized for example as presented in FIG. 1, and can be thought of as a cycle, as indicated by arrow 10.

A cardholder 12 may present a payment card 14 to a merchant 16 as payment for goods and/or services. The payment card 14 here is emblematic of any transaction device, real or virtual, by which the cardholder and/or the source of funds for the payment may be identified.

In cases where the merchant 16 has an established merchant account with an acquiring bank (also called the acquirer) 20, the merchant communicates with the acquirer to secure payment on the transaction. An acquirer 20 is a party or entity, typically a bank, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction thought a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment card 14 from a cardholder 12, despite not having a merchant account with an acquirer 20.

The acquirer 20 routes the transaction request to the network operator 22. The data included in the transaction request will identify the source of funds for the transaction. With this information, the network operator routes the transaction to the issuer 24. An issuer 24 is a party or entity, typically a bank, which is authorized by the network operator 22 to issue payment cards 14 on behalf of its customers (e.g., cardholder 12) for use in transactions to be completed on the network. The issuer 24 also provides the funding of the transaction to the network provider 22 for transactions that it approves in the process described. The issuer 24 may approve or authorize the transaction request based on criteria such as a cardholder's credit limit, account balance, or in certain instances more detailed and particularized criteria including transaction amount, merchant classification, etc., which may optionally be determined in advance in consultation with the cardholder and/or a party having financial ownership or responsibility for the account(s) funding the payment card, if not solely the cardholder 12.

The issuer 24 decision to authorize or decline the transaction is routed through the network operator 22 and acquirer 20, ultimately to the merchant 16 at the point of sale. This entire process is typically carried out by electronic communication, and under routine circumstances (i.e., valid card, adequate funds, etc.) can be completed in a matter of seconds. It permits the merchant 16 to engage in transactions with a cardholder 12, and the cardholder 12 to partake of the benefits of cashless payment, while the merchant 16 can be assured that payment is secured. This is enabled without the need for a preexisting one-to-one relationship between the merchant 16 and every cardholder 12 with whom they may engage in a transaction.

The authorization may also be separate in time from the consummation of the transaction. In some cases, an authorization will be taken by a merchant 16, but payment is not made until goods are delivered or the services performed some time later. In any case, on a periodic basis, e.g., daily, the merchant 16 will submit a batch of completed and authorized transactions to the acquirer 20 to receive payment. The acquirer will in turn look to the network operator for payment in a process called “clearing”. The clearing records, or list of cleared transactions including data relevant thereto in form and content specified by the network operator 22, is transmitted to the issuer 24.

The issuer 24 may then look to its customer, e.g., cardholder 12 or other party having financial ownership or responsibility for the account(s) funding the payment card, for payment on approved transactions, for example through an existing line of credit where the payment card 14 is a credit card, or from funds on deposit where the payment card 14 is a debit card. The issuer 24 will prepare a periodic statement 26 listing transactions on the account of a cardholder 12, including merchant data as provided by the network operator 22.

Conventionally, the cardholder's periodic statement 26 contains only minimal information pertaining to the merchant and the network operator. Specifically, the statement 26 will typically only identify the name of the merchant 16 and, perhaps, a location of the merchant. It is often desirable, from the point of view of both the merchant 16 and the network operator 22, to provide the cardholder 12 with additional information within the periodic statement 26 pertaining to the merchant and/or network operator. For example, additional information provided within the statement 26, which might entice the cardholder 12 to purchase additional goods and/or services from the merchant 16 and/or further utilize the services of the network operator 22 would naturally benefit the merchant and/or network operator.

Accordingly, it would be desirable to provide a method and system in which such information can be automatically communicated to the client based on certain predetermined criteria.

### SUMMARY OF THE INVENTION

The present invention involves a method for providing enhanced merchant information to the user of a cashless payment device. The method generally includes the step of receiving a transaction request from an acquirer on behalf of a merchant in a cashless transaction clearing record, wherein the transaction request includes data identifying the merchant and the payment device. The data identifying the merchant is then compared to a database including a list of participating merchants to determine if a match exists in the database. In response to determining a match exists in the database between the data identifying the merchant in the transaction request and the list of participating merchants, it is then determined whether the data identifying the merchant in the transaction request should be enhanced with additional merchant information or information related to a program the merchant participates in. If so, data enhancement is performed and the transaction request having the additional merchant or program information is forwarded to an issuer of the payment device.

In a preferred embodiment, the method further includes the steps of comparing the data identifying the merchant to a database including merchant add-on data entries to determine if a match exists in the database and, in response to determining a match exists in the database, appending the merchant add-on data entry to the transaction request before forwarding the transaction request to the issuer of the payment device.

The add-on data entry for the corresponding merchant or program the merchant participates in may include one or more of a legal entity name of the merchant or program, a URL of the merchant or program, a telephone number of the merchant, informative text relating to the merchant or program, text which may include a call to action with respect to the merchant, or any combination of the above. The add-on data entry for the corresponding merchant may also include information relating to services provided by the merchant, including, for example, an offers program, a points based rewards/loyalty program, a cash-back based rewards/loyalty program, a rebate based rewards/loyalty program, or any combination of the above.

The method further preferably includes the steps of identifying secondary information within the transaction request, comparing the secondary information to a database including secondary criteria data entries to determine if a match exists in the database and, in response to determining a match exists in the database, performing the data enhancement before forwarding the transaction request having the additional merchant information to an issuer of the payment device. Such secondary criteria may include at least one of a transaction date, a transaction time, a transaction location, a transaction point of sale entry mode, an indication of a cross-border transaction, or any combination of the above.

The present invention further involves a system for providing enhanced merchant information to the user of a cashless payment device, wherein the system generally includes a processor and a computer-readable storage medium having a program of instruction thereon, which when executed by the processor cause the system to perform the method steps described above.

The present invention further involves a computer-readable storage medium having a program of instruction thereon, which when executed by a processor causes a system to perform the method steps described above.

As a result of the present invention, MasterCard International Incorporated, the assignee of the instant application, in its capacity as network operator 22 in the above-described process has developed a solution to provide enhanced information to its cardholders through the clearing records in a real-time manner. According to the present disclosure, the network operator 22 sends the issuer 24 an outbound clearing data file enriched with additional merchant and/or network operator data. Merchants 16 that choose to participate in the enhanced merchant data service will have information pertaining to themselves either enhanced or augmented on the cardholders' periodic statements or appended with information about a program they participate in. Providing this enhanced data to the cardholder 12 will benefit both the merchants 16 and the network operators 22 through repeat business and increased sales.

A preferred form of the method according to the present invention, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 illustrates a cycle for cashless transaction processing.

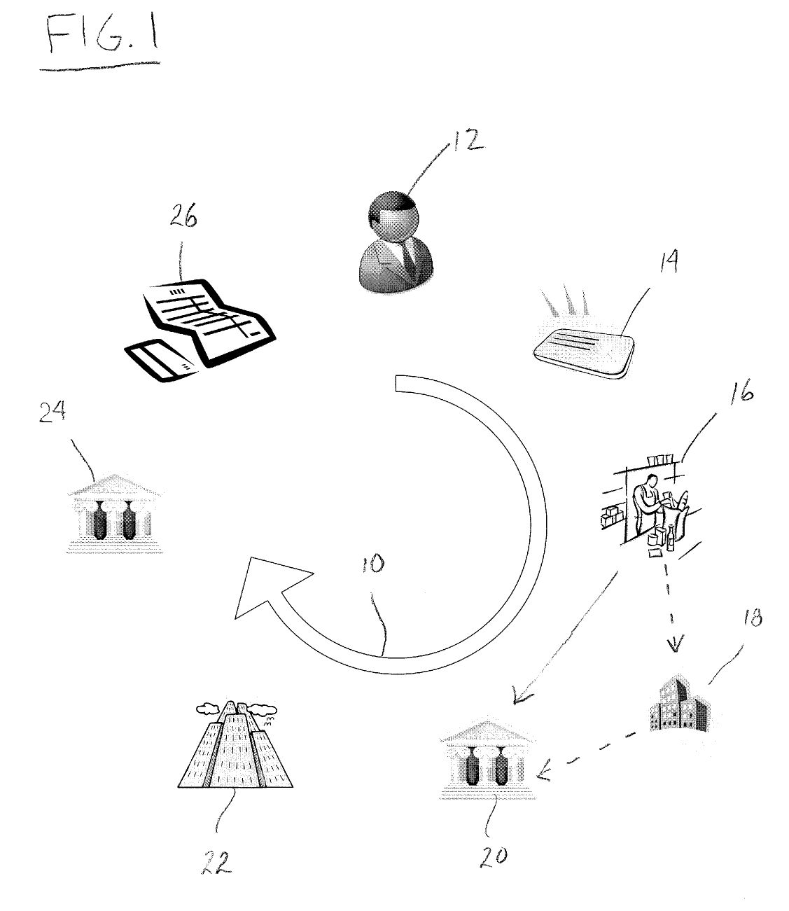

FIG. 2 is a schematic diagram of a card-based payment system.

FIG. 3 is a flow diagram depicting the process for implementing merchant data enhancement according to a first embodiment of the present disclosure.

FIG. 4 is a flow chart depicting the process for implementing merchant data enhancement according to a second embodiment of the present disclosure.

FIG. 5 illustrates a network-enabled system according to a further embodiment of the present disclosure.

FIG. 6 schematically illustrates a representative server of the system

### DETAILED DESCRIPTION OF THE INVENTION

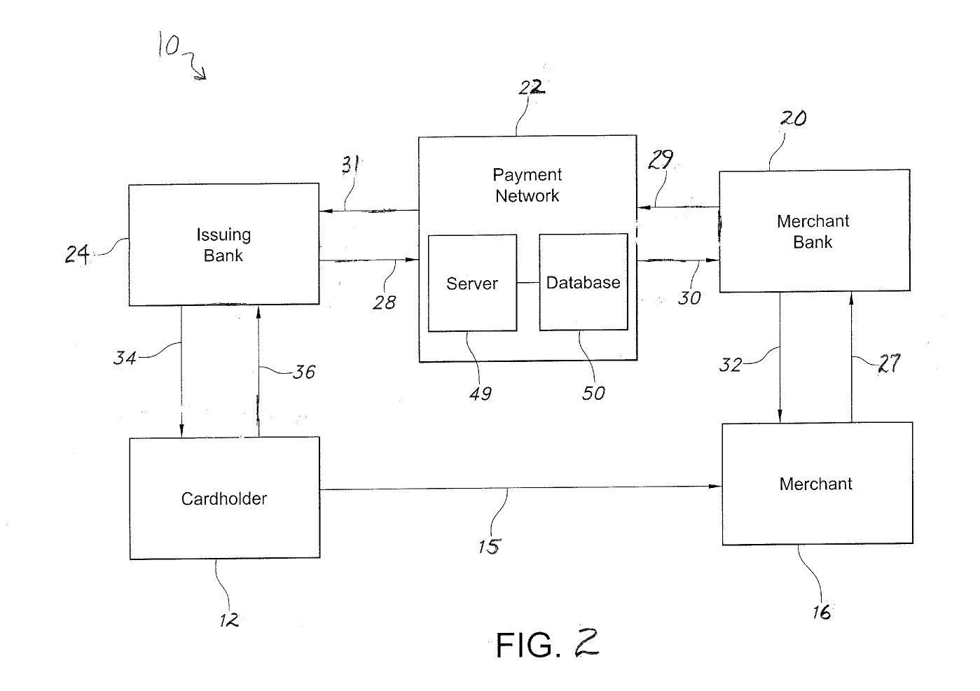

As will be recognized by those skilled in the art, the transaction processing of card-based payments include both an authorization side and a clearance side. The authorization side involves the process of confirming that the cardholder has a sufficient line of credit to cover the proposed payment. The clearance side of the transaction involves the process of moving funds from the issuing bank to the merchant bank. FIG. 2 depicts a transaction processing flow chart showing both the authorization side and the clearance side of the card-based payment.

In a typical card-based payment system transaction, a cardholder 12 presents his credit/debit/prepaid card 14 to a merchant 12 for the purchase of goods and/or services. This transaction is indicated by arrow 15. The “card” 14, as used herein, may be a conventional magnetic-stripe credit or debit card or may be a proximity payment device having a conventional RFID chip stored therein.

It will be understood that prior to the occurrence of this transaction, the cardholder 12 was issued a card 14 by an issuing bank 24. Moreover, it will be understood that the merchant 16 has established a relationship with a merchant bank 20, thereby allowing the merchant 16 to receive credit/debit cards as payment for goods and/or services. The merchant banks and issuing banks may participate in various payment networks, including payment network 22. One such payment network is referred to as the MasterCard Worldwide Network.

After presentation of a card 14 to the merchant 16 by cardholder 12, the merchant 16 sends an authorization request (indicated by arrow 27) to the merchant's bank 20 via a point-of sale (POS) terminal located at the merchant. In turn, the merchant's bank 20 communicates with the network operator 22 (indicated by arrow 29), and the network 22 communicates with the issuing bank 24 (indicated by arrow 31) to determine whether the cardholder is authorized to make the transaction 15 in question. An approval or disapproval of the authorization request is thereafter transmitted back to the merchant 16 (indicated by arrows 28, 30 and 32). The merchant 16 thereafter either completes or cancels the transaction 15 based upon the response to the authorization request.

If the transaction 15 is approved, the transaction amount will be sent from issuing bank 16 through the network operator 22 to the merchant's bank 20. This transaction amount, minus certain fees charged by both the network operator 22 and the merchant's bank 20, will thereafter be deposited within a bank account belonging to the merchant 16. The issuing bank 24 thereafter bills the cardholder 12 (indicated by arrow 34) for the amount of such transaction by sending a cardholder statement 26. The cardholder 12 follows by a submission of payment(s) (as indicated by arrow 36) to the issuing bank 24. This submission of payment(s) (as indicated by arrow 36) by the cardholder 12 may be automated (e.g., in the case of debit transactions), may be initiated by the cardholder for the exact amount matching costs of purchases during the statement period (e.g., charge cards or credit balances paid in full), and/or may be submitted (in part or in whole) over a period of time that thereby reflects the costs of the purchases plus financing charges agreed upon beforehand between the cardholder and the cardholder's issuing bank (e.g., revolving credit balances.)

The network operator 22 preferably includes at least one server 49 and at least one database 50. The server 49 may include various computing devices such as a mainframe, personal computer (PC), laptop, workstation or the like. The server can include a processing device and be configured to implement an authorization and clearance process, which can be stored in computer storage associated with the server. The database 50 may include computer readable medium storage technologies such as a floppy drive, hard drive, tape drive, flash drive, optical drive, read-only memory (ROM), random access memory (RAM), and/or the like. The payment system server 49 and database 50 may be conventional in its hardware aspects but may be controlled by software and may store data to allow it to operate in accordance with aspects of the present invention.

The POS terminal at the merchant's location is in data communication, directly or indirectly, and at least from time to time, with a host computer that is part of the payment card transaction processing system 22 and is operated for or on behalf of the acquirer financial institution 20, which handles payment card transactions for the merchant 16 which operates the POS terminal. Both the acquirer host computer and the POS terminal may be constituted and may operate in a conventional manner.

In accordance with conventional practices, the payment system server 49 may be operated by or on behalf of the network operator 22 (of which a prominent example is MasterCard International Incorporated, the assignee hereof) and provides the central switching and message routing functions among the member financial institutions of the payment card association. The issuing bank 24 will also preferably make use of an issuer host computer, and an access point via which the issuer host computer exchanges data messages with the payment system server 49. It should be understood that in practice the payment card transaction processing system 10 may involve a large number of cardholders, POS terminals, acquirer host computers, issuer host computers, and access points.

In some embodiments, all of the components of the payment card transaction processing system 10 may be entirely or substantially conventional, except that the payment system computer 49 and database 50 may store data and may be programmed to perform functions in accordance with aspects of the present invention. In general, the acquirer host computer performs its conventional functions of receiving authorization requests from POS terminals, forwarding the authorization requests through the payment card transaction processing system 22, receiving authorization responses, and relaying the authorization responses to the POS terminals. Moreover, the issuer host computer may in general perform its conventional function of receiving authorization requests from the payment system computer 49 and transmitting authorization responses back to the payment system computer with respect to the authorization requests.

The payment system server 49 is preferably operatively coupled to a communication device, an input device and an output device. The server 49 may be constituted by one or more conventional processors, which operate to execute processor-executable steps, contained in program instructions, so as to control the payment system computer to provide desired functionality. The communication device may be used to facilitate communication with, for example, other devices (such as access points, acquirer host computer and issuer host computer. The input device may comprise one or more of any type of peripheral device typically used to input data into a computer. For example, the input device may include a keyboard and a mouse. The output device may comprise, for example, a display and/or a printer.

The network operator database 50 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory.

The database 50 further stores one or more programs for controlling the server 49 in accordance with the present invention. The programs comprise program instructions that contain processor-executable process steps, including, in some cases, process steps that constitute processes provided in accordance with principles of the present invention, as described in more detail below.

The programs may include a database management application that allows the payment system computer to generate, maintain, update and query certain databases that are described below. The programs may also include an application program for processing authorization requests sent to the payment system computer from acquirer host computers. As will be seen, in a larger sense, the process of handling authorization requests also entails processing authorization responses sent to the payment system computer by issuer host computers in response to authorization requests.

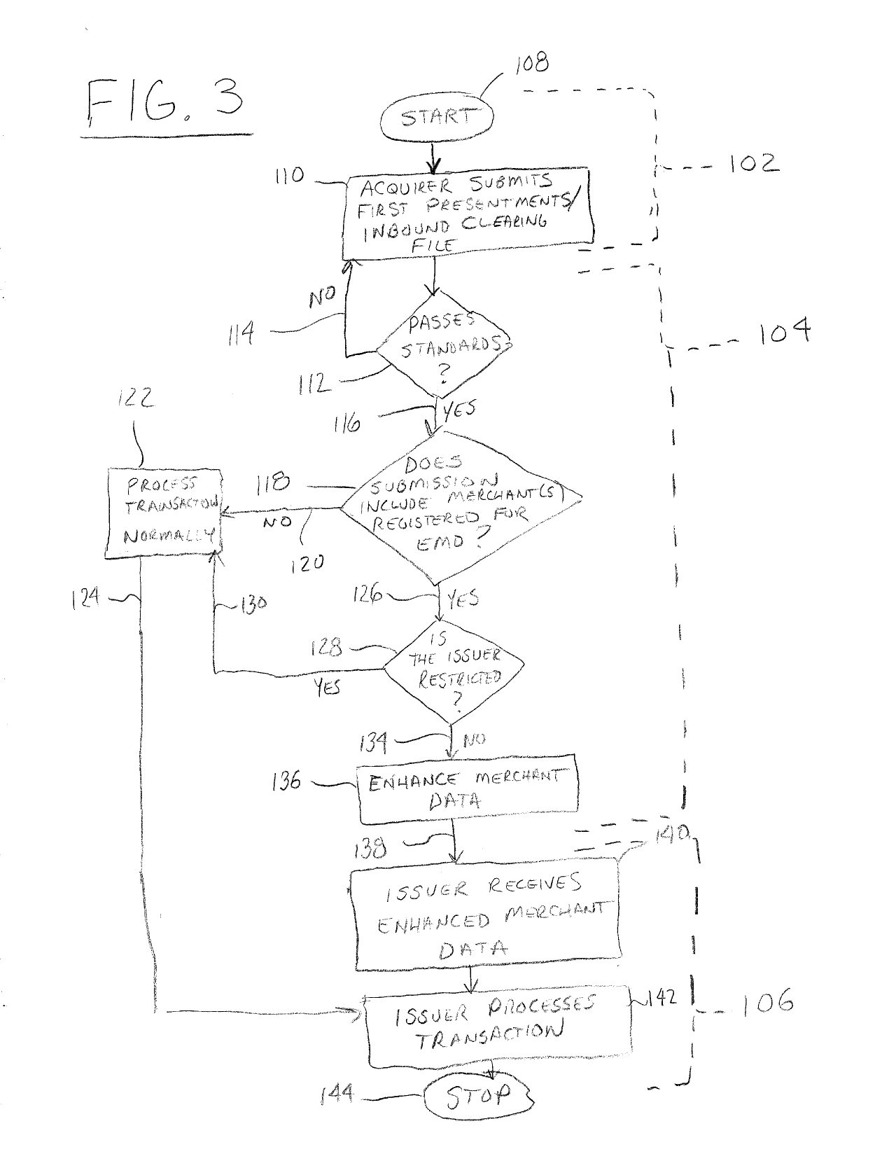

Referring now to FIG. 3, the process for implementing merchant data enhancement according to a first embodiment of the present invention is shown. The process described and depicted herein may require that the merchant 16 and the issuing bank 24 had affirmatively enrolled in an enhanced merchant data program with the network operator 22. This is so because operation of the enhanced merchant data program may involve deviations from the data formatting protocols that were previously established, and will remain in effect with respect to those merchants and issuers not participating in the enhanced merchant data program, subject of course to routine and unrelated revisions in the future course of the parties' business. Enrollment may include a request to enroll by or on behalf of the merchant 16, and an acceptance by the issuer 24 of terms and conditions of participation in the enhanced merchant data program.

In response to the enrollment request by the merchant 16 and as part of the acceptance of that request by the network operator 22 and the issuer 24, the issuer 24 may be permitted to select some or all of Interbank Card Association (ICA) numbers and/or Bank Identification Numbers (BIN) associated with that issuer 24, and which make up part of an account number assigned to the payment card 14 issued to a cardholder 12. In this way, the network operator 22 can refer to the selection of ICA/BIN, for example via a lookup table, in the ordinary course of processing merchant 16/acquirer 20 transaction requests in order to determine whether to invoke the enhanced merchant data program for any particular transaction.

Referring now to FIG. 3, a flowchart describing the process for implementing merchant data enhancement according to a first embodiment of the instant disclosure is presented. The flowchart is divided into three vertical layers, a first layer 102 representing actions of the acquirer 20, a second and intermediate layer 104 representing the actions of a network operator 22, and a third layer 106 representing the actions of an issuer 24. An acquirer 20 begins the process 108 and submits 110 to the network operator 22 their first presentments of completed transactions in an inbound clearing file to clear the transactions. The network operator 22 checks the submission for conformance with its standards 112. If found out of compliance it is rejected and returned 114 to the acquirer 20. If found in compliance, the process proceeds 116.

The network operator 20 next determines at 118 whether any particular transaction among those submitted for clearing 110 involves a merchant previously registered for participation in the enhanced merchant data program. If the submission by the acquirer 20 is found to include no merchants 16 registered for the enhanced merchant data program 120, then the transaction is processed normally at 122, i.e., without invoking the features of the enhanced merchant data program. The normally processed transaction is then forwarded 124 onto the issuer 24.

On the other hand, upon determining that the submission in question includes a merchant 16 registered for the enhanced merchant data program 126, an issuer check can be performed 128. It may be the case that certain issuing banks 24 or individual cardholders 12 are excluded from consideration and/or participation in the enhanced merchant data program. This exclusion may be individual or by some category or class. The exclusion may be voluntary, or imposed by applicable law or regulation. For example, certain countries may restrict by law operations by network operators 22 that may be considered to be of the type described herein. If the issuer check 128 indicates that the enhanced merchant data may not be invoked for that reason, then the transaction is routed 130 for normal processing 122 in connection with the decision.

Among the normal processing 122, the network operator 22 will leave in place the transaction data supplied by the acquirer 20, which was to have been eligible for supplementation in accordance with the enhanced merchant data program. The normal processing 122 may further supplement the transaction data to indicate to the issuer 24 that the application of the enhanced merchant data program to that transaction was suspended. This supplemental indication may include a reason for the suspension of the enhanced merchant data program for that transaction.

Upon determining that a transaction is eligible for processing under the enhanced merchant data program based upon the merchant identity, the transaction is forwarded 134 to invoke the enhanced merchant data process 136. The enhanced merchant data process looks to a pre-established merchant database, including enhanced merchant data, and adds enhanced merchant data to the base data supplied by the acquirer.

The additional enhanced merchant data may include, without limitation, cleansed versions of the merchant's “Doing Business As” (or DBA) name, which is a trade name by which the business is known to its customers irrespective of its legal entity name, the merchant's street address, the merchant's city, the merchant's postal code, the merchant's state, the merchant's country, the merchant's URL address, the merchant's phone number, informative text relating to the merchant or program the merchant participates in, text which may include a call to action with respect to the merchant or program the merchant participates in (e.g., instructions to contact the merchant via telephone or the internet), or any combination of the above. In addition, or in the alternative, the additional enhanced merchant data may include information relating to services provided by the merchants, or program the merchant participates in, including, but not limited to, offers programs, points based rewards/loyalty programs, cash-back based rewards/loyalty programs, rebate based rewards/loyalty programs or any combination of the above.

Thus, in step 136, the network provider enhances the merchant data “add-on” data pre-specified by the merchant 16 or the network provider 22. Such add-on data is data that does not merely replace the merchant data in the transaction data provided by the acquirer 20. Instead, add-on data is data specific to the merchant that would not have been included in the transaction clearing record according to present standards, but is nonetheless useful or valuable to the card-holder.

Upon enhancement of the merchant data with information as described above, the transaction processing then proceeds to deliver 138 the enhanced transaction data to the issuer. The issuer receives 140 the enhanced merchant data 158 and continues to process 142 the transaction at its end by supplying the cardholder with a statement having the enhanced merchant data. In cases where the enhanced merchant data program is not invoked, as illustrated in step 122, the issuer receives the transaction data, without the enhanced merchant data 158, and continues to process 142 the transaction at its end by supplying the cardholder with a statement without the enhanced merchant data. Thereafter, the enhanced merchant data process according to the first embodiment of the present disclosure is considered terminated 144.

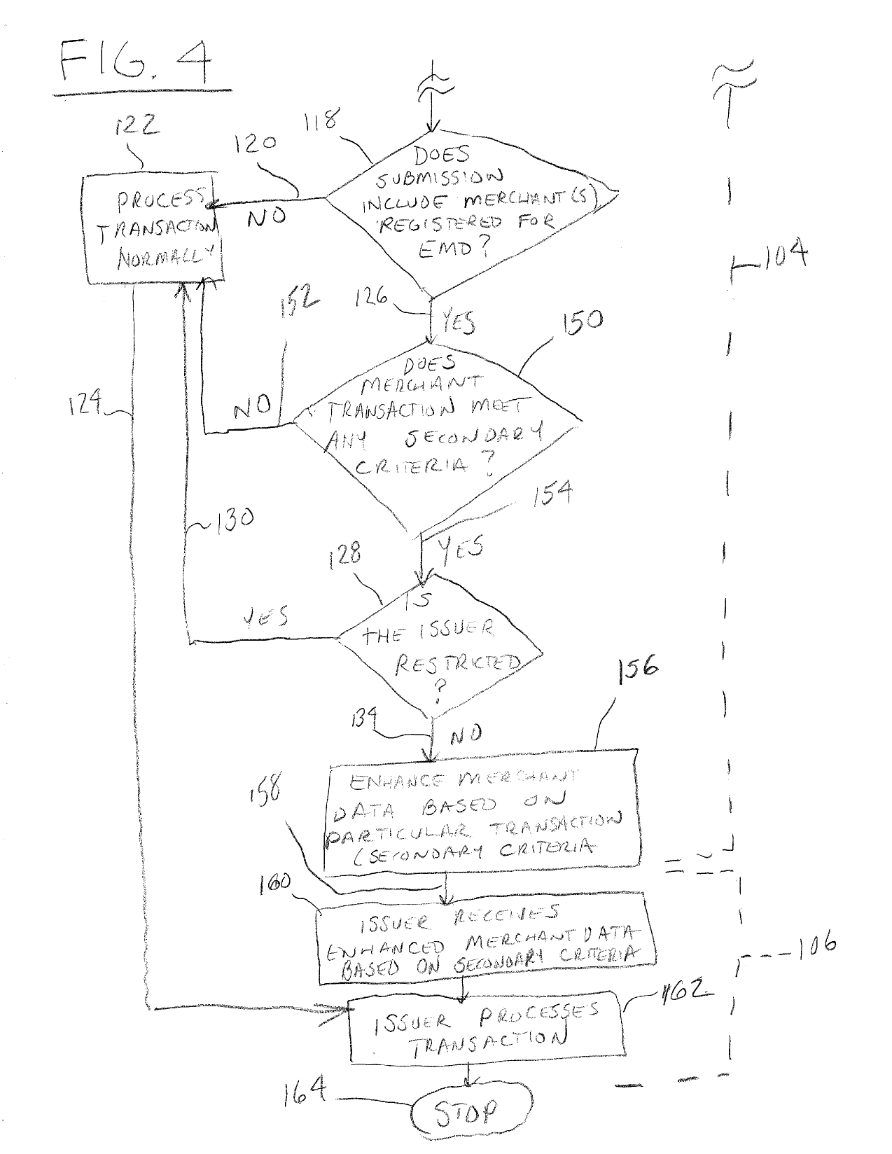

Turning now to FIG. 4, a flowchart illustrating the process for implementing enhanced merchant data according to a second embodiment of the instant disclosure is shown. Whereas the first embodiment described above implements the enhanced merchant data process based on first-level criteria involving mere participation of a merchant in the program, the second embodiment of the present invention looks to additional second-level criteria to invoke the process.

In particular, the second embodiment process illustrated by the flowchart of FIG. 4 includes the same initial steps as that of the process according to the first embodiment up to and including the step 118 of determining whether the submission by the acquirer identifies one or more merchants participating in the enhanced merchant data program. Thus, where the second embodiment is the same as or similar to the first, like reference numerals appear in FIG. 4 as in FIG. 3, and a complete description of these features will be omitted, for the sake of brevity and in light of the foregoing full description. However, the process according to the second embodiment of the present invention includes additional steps to determine whether the enhanced merchant data program is invoked.

Accordingly, following the step 118 of determining whether the submission by the acquirer identifies one or more merchants participating in the enhanced merchant data program, the second embodiment deviates from the first embodiment of the present disclosure in that the incoming transaction will be checked 150 against a secondary list of criteria, as compared with the first embodiment. Such secondary list of criteria for implementing the enhanced merchant data process may include, but is not limited to, the transaction date and time, transaction location, transaction point of sale entry mode, (e.g., card swipe, card not present (CNP), card proximity device, internet), cross-border transaction, or any combination of the above. Such secondary criteria permits the merchant 16 to specifically tailor and simultaneously offer multiple levels of the enhanced merchant data service to various individual card holders 12.

If the transaction does not meet any of the secondary criteria established for that particular merchant 152, then the transaction is processed normally at 122, i.e., without invoking the features of the enhanced merchant data program. The normally processed transaction is then forwarded 124 to the issuer 24. Upon determining that a transaction meets any of the secondary criteria established by the particular merchant 154 and is, therefore, eligible for processing under the enhanced merchant data program with add-on data based upon the secondary criteria, an issuer check 128 can be performed, as described above. If the issuer check 128 indicates that the enhanced merchant data may not be invoked for that reason, then the transaction is routed 130 for normal processing 122 in connection with the decision.

If the issuer is not restricted 134, the transaction is forwarded to invoke the cleansed merchant data process including add-on data based on secondary criteria 156. The enhanced merchant data process looks to a pre-established enhanced merchant database, including the prescribed list of secondary criteria, together with associated add-on data of the type described above, among other pertinent merchant-specific add-on data. The process assigns certain particular add-on data based on the matching secondary criteria and forwards 158 the enhanced merchant data to the issuer. The issuer receives the clearing data 160, including the enhanced merchant data based on secondary criteria, as described above, according to this second embodiment, and continues to process 142 the transaction at its end by supplying the cardholder with a statement with the enhanced merchant data. Thereafter, the enhanced merchant data process according to the second embodiment of the present disclosure is considered terminated 164.

While it is presently contemplated that the second embodiment as described will include and incorporate all features of the first embodiment, this is not necessarily required to be the case. The network operator may find it advantageous to offer the enhanced add-on data service separate and apart from active participation by the merchants. For example, it is conceivable for the network operator to offer such service to cardholders associated with a particular ICA and/or BIN for all merchants in a specific geographic area, or merchant category. If such first-level criteria are matched, the network provider may enhance that particular cardholder's transaction data with add-on data related to information and/or services provided by the network provider for all the merchants in a specific geographic region or merchant category.

Similar to that described above, such information may include, without limitation, a program URL address, phone number, informative text relating to the program, text which may include a call to action with respect to the program (e.g., instructions to contact the program provider via telephone or the internet), or any combination of the above. The program may be, but is not limited to, an offers program, a points based rewards/loyalty program, a cash-back based rewards/loyalty program, a rebate based rewards/loyalty program or any combination of the above.

The foregoing processes have been described with reference to what it known in the industry as a dual-message acquirer. This term is used to describe what most consumers understand as a credit transaction or a signature debit. On the other hand, there also exists a single-message transaction, typically involving a debit card linked to or drawing from a demand deposit account. In that case, the transaction is authorized by a PIN number input by the cardholder 12, optionally in addition to a signature. A dual-message transaction involves, as the name suggests, two messages to complete a charge transaction. However, the application of the enhanced merchant data program is not substantively affected by the dual-message protocol, or the involvement of a merchant data service provider as intermediary between the network operator 22 and the issuer 24.

It will be appreciated by those skilled in the art that the enhanced merchant data process as described above may be operated by a machine operator having a suitable interface mechanism, and/or more typically in an automated manner, for example by operation of a network-enabled computer system including a processor executing a system of instructions stored on a machine-readable medium, RAM, hard disk drive, or the like. The instructions will cause the processor to operate in accordance with the present disclosure.

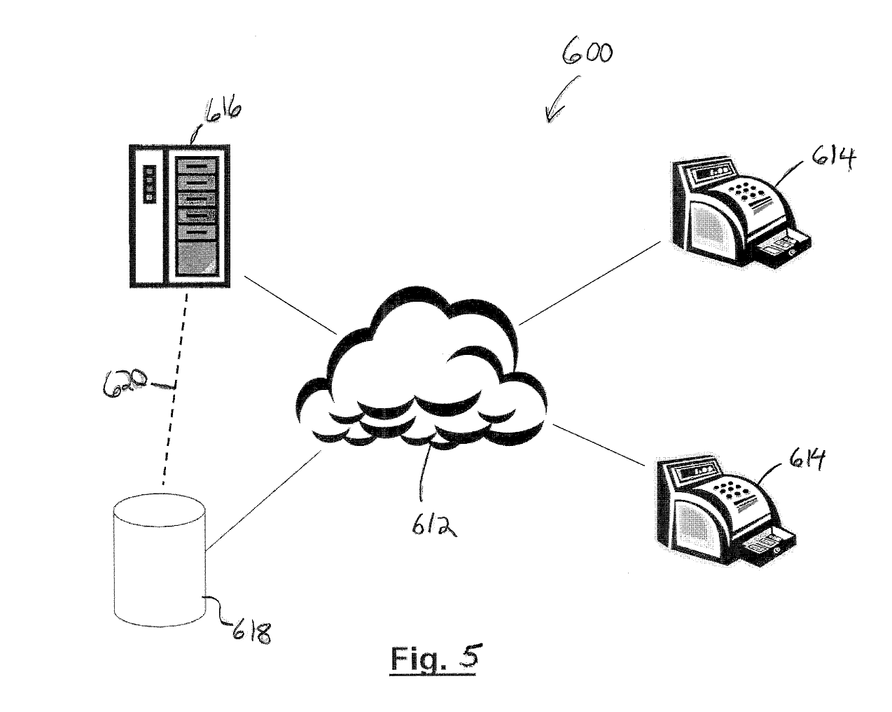

Turning then to FIG. 5, a network-enabled system 600, as a further embodiment of the present disclosure, is described. A telecommunication network 612 enables information exchange among the various components of the system. Network 612 may comprise an Internet, an intranet, Ethernet, virtual private network (VPN), cellular, WiFi, or substantially any means or modality by which telecommunication machines, or components thereof, exchange data or information with each other. The network 612 may comprise a composite of several different of these or other telecommunication modes. The network 612 may connect components that are physically co-located, for example a computer or processing device that shares an internal data bus (e.g., PCI, SATA) with one or more storage means.

Point-of-sale 614 represents the point of origination of a transaction, whether tangible (e.g., brick-and-mortar or other location), internet-based, as in an e-commerce transaction regardless of the physical location of the cardholder 12 or the merchant 16. Point of sale 614 for the purposes of FIG. 5 further includes any intermediaries (third party payment provider 18, acquirer 20, etc.) as may be necessary to deliver the transaction data to the network operator 22.

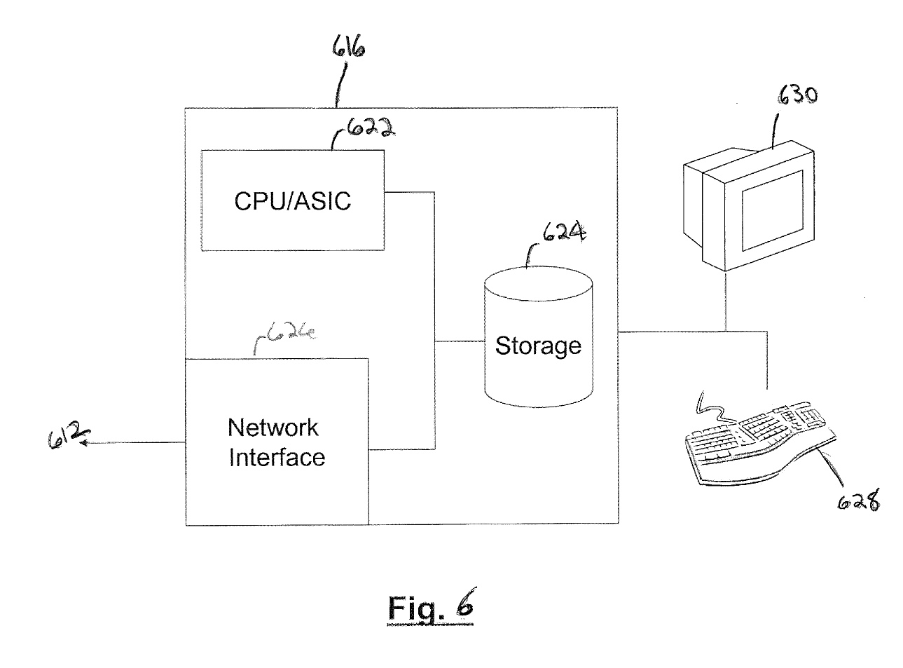

Network operator 22 maintains operational control of a server 616 including a processing device 622 for carrying out transaction processing and optionally storage 624 maintaining instructions executable by the processor (See FIG. 6). Network operator 22 also maintain access between the transaction processing server 616 and a database 618 or other suitable means for storage of merchant information. The database 618 includes data pertaining to the participating merchants, the secondary criteria established by the merchants and merchant add-on information entries. Server 616 and database 618 may each include plural, several, shared, divided and/or redundant machines as the network operator 22 finds necessary or convenient, including the necessary operational capacity to divide the processing of volumes of transactions and/or access to data entries among such plural, etc., machines. The dataflow connection between the server 616 and the database 618 may make use of the network 612, or employ a more direct connection 620.

FIG. 6 illustrates schematically a representative server 616 of the system 600. The server 616 includes at least a processor or CPU 622 which is operative to act on a program of instructions stored on a computer-readable medium 624. Execution of the program of instruction causes the processor to carry out, for example, the methods described above according to the various embodiments. It may further or alternately be the case that the processor 622 comprises application-specific circuitry including the operative capability to execute the prescribed operations integrated therein. The server 616 includes a network interface 626 for communication with the network 612. Optionally or additionally, a data entry device 628 (e.g., keyboard, mouse, trackball, pointer, etc.) facilitates human interaction with the server, as does an optional display 630.

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendments and/or deviations be included in the scope of the present invention.

What is claimed is:

1. A method for providing enhanced merchant information to the user of a cashless payment device, the method comprising:
receiving a transaction request from an acquirer on behalf of a merchant in a cashless transaction clearing record, the transaction request including data identifying the merchant and the payment device;
comparing the data identifying the merchant to a database including a list of participating merchants to determine if a match exists in the database;
in response to determining a match exists in the database between the data identifying the merchant in the transaction request and the list of participating merchants, determining whether the data identifying the merchant in the transaction request should be enhanced with additional merchant information or information about a program the merchant participates in;
in response to determining that the data identifying the merchant should be enhanced with the additional merchant or program information, performing the data enhancement; and
forwarding the transaction request having the additional merchant or program information to an issuer of the payment device.

2. The method as defined in claim 1, further comprising:
comparing the data identifying the merchant to a database including merchant add-on data entries to determine if a match exists in the database; and
in response to determining a match exists in the database between a merchant add-on data entry and the data identifying the merchant in the transaction request, appending the merchant add-on data entry to the transaction request before forwarding the transaction request to the issuer of the payment device.

3. The method as defined in claim 2, wherein an add-on data entry comprises, for the corresponding merchant, one or more of a legal entity name of the merchant, a URL of the merchant, a telephone number of the merchant, informative text relating to the merchant, text which may include a call to action with respect to the merchant, or any combination of the above.

4. The method as defined in claim 2, wherein an add-on data entry comprises, for the corresponding merchant, information relating to services provided by the merchant or a provider of the program the merchant participates in.

5. The method as defined in claim 4, wherein the information related to services provided by the merchant or the provider comprises one or more of an offers program, a points based rewards/loyalty program, a cash-back based rewards/loyalty program, a rebate based rewards/loyalty program, or any combination of the above.

6. The method as defined in claim 1, further comprising:
identifying secondary information within the transaction request;
comparing the secondary information to a database including secondary criteria data entries to determine if a match exists in the database; and
in response to determining a match exists in the database between the secondary information and the secondary criteria, performing the data enhancement before forwarding the transaction request having the additional merchant or program information to an issuer of the payment device.

7. The method as defined in claim 6, wherein the secondary criteria comprises at least one of a transaction date, a transaction time, a transaction location, a transaction point of sale entry mode, an indication of a cross-border transaction, or any combination of the above.

8. The method as defined in claim 1, further comprising:
indicating to the issuing entity that the merchant data enhancement was performed.

9. A system for providing enhanced merchant information to the user of a cashless payment device, the system comprising:
a processor; and
a computer-readable storage medium having a program of instruction thereon, which when executed by the processor cause the system to
receive a transaction request from an acquirer on behalf of a merchant in a cashless transaction clearing record, the transaction request including data identifying the merchant and the payment device;
compare the data identifying the merchant to a database including a list of participating merchants to determine if a match exists in the database;
in response to determining a match exists in the database between the data identifying the merchant in the transaction request and the list of participating merchants, determine whether the data identifying the merchant in the transaction request should be enhanced with additional merchant information or information about a program the merchant participates in;
in response to determining that the data identifying the merchant should be enhanced with the additional merchant or program information, perform the data enhancement; and
forward the transaction request having the additional merchant or program information to an issuer of the payment device.

10. The system as defined in claim 9, wherein the program of instruction, when executed by the processor, further causes the system to:
compare the data identifying the merchant to a database including merchant add-on data entries to determine if a match exists in the database; and
in response to determining a match exists in the database between a merchant add-on data entry and the data identifying the merchant in the transaction request, append the merchant add-on data entry to the transaction request before forwarding the transaction request to the issuer of the payment device.

11. The system as defined in claim 10, wherein an add-on data entry comprises, for the corresponding merchant, one or more of a legal entity name of the merchant, a URL of the merchant, a telephone number of the merchant, informative text relating to the merchant, text which may include a call to action with respect to the merchant, or any combination of the above.

12. The system as defined in claim 9, wherein an add-on data entry comprises, for the corresponding merchant, information relating to services provided by the merchant or a provider of the program the merchant participates in.

13. The system as defined in claim 12, wherein the information related to services provided by the merchant or the provider comprises one or more of an offers program, a points based rewards/loyalty program, a cash-back based rewards/loyalty program, a rebate based rewards/loyalty program, or any combination of the above.

14. The system as defined in claim 9, wherein the program of instruction, when executed by the processor, further causes the system to:
identify secondary information within the transaction request;
compare the secondary information to a database including secondary criteria data entries to determine if a match exists in the database; and
in response to determining a match exists in the database between the secondary information and the secondary criteria, perform the data enhancement before forwarding the transaction request having the additional merchant or program information to an issuer of the payment device.

15. The system as defined in claim 14, wherein the secondary criteria comprises at least one of a transaction date, a transaction time, a transaction location, a transaction point of sale entry mode, an indication of a cross-border transaction, or any combination of the above.

16. The system as defined in claim 9, wherein the program of instruction, when executed by the processor, further causes the system to:
indicate to the issuing entity that the merchant data enhancement was performed.

17. A computer-readable storage medium having a program of instruction thereon, which when executed by a processor causes a system to:
receive a transaction request from an acquirer on behalf of a merchant in a cashless transaction clearing record, the transaction request including data identifying the merchant and the payment device;
compare the data identifying the merchant to a database including a list of participating merchants to determine if a match exists in the database;
in response to determining a match exists in the database between the data identifying the merchant in the transaction request and the list of participating merchants, determine whether the data identifying the merchant in the transaction request should be enhanced with additional merchant information or information about a program the merchant participates in;
in response to determining that the data identifying the merchant should be enhanced with the additional merchant or program information, perform the data enhancement; and
forward the transaction request having the additional merchant information to an issuer of the payment device.

18. The medium as defined in claim 17, wherein the program of instruction, when executed by the processor, further causes the system to:
compare the data identifying the merchant to a database including merchant add-on data entries to determine if a match exists in the database;
in response to determining a match exists in the database between a merchant add-on data entry and the data identifying the merchant in the transaction request, append the merchant add-on data entry to the transaction request before forwarding the transaction request to the issuer of the payment device.

19. The medium as defined in claim 18, wherein an add-on data entry comprises, for the corresponding merchant, one or more of a legal entity name of the merchant, a URL of the merchant, a telephone number of the merchant, informative text relating to the merchant, text which may include a call to action with respect to the merchant, or any combination of the above.

20. The medium as defined in claim 18, wherein an add-on data entry comprises, for the corresponding merchant, information relating to services provided by the merchant or a provider of the program the merchant participates in.

21. The medium as defined in claim 20, wherein the information related to services provided by the merchant or the provider comprises one or more of an offers program, a points based rewards/loyalty program, a cash-back based rewards/loyalty program, a rebate based rewards/loyalty program, or any combination of the above.

22. The medium as defined in claim 17, wherein the program of instruction, when executed by the processor, further causes the system to:
identify secondary information within the transaction request;
compare the secondary information to a database including secondary criteria data entries to determine if a match exists in the database; and
in response to determining a match exists in the database between the secondary information and the secondary criteria, perform the data enhancement before forwarding the transaction request having the additional merchant or program information to an issuer of the payment device.

23. The medium as defined in claim 22, wherein the secondary criteria comprises at least one of a transaction date, a transaction time, a transaction location, a transaction point of sale entry mode, an indication of a cross-border transaction, or any combination of the above.

24. The medium as defined in claim 17, wherein the program of instruction, when executed by the processor, further causes the system to:
indicate to the issuing entity that the merchant data enhancement was performed.
